(19) United States
(12) Patent Application Publication
(10) Pub. No.: US 2016/0170945 A1
(43) Pub. Date: Jun. 16, 2016

(54) INFORMATION PROCESSING DEVICE, INFORMATION PROCESSING METHOD, AND COMPUTER PROGRAM PRODUCT

(71) Applicant: Kabushiki Kaisha Toshiba, Minato-ku (JP)

(72) Inventors: Narumichi Sakai, Fujisawa (JP); Hiroyuki Aizu, Yokohama (JP)

(73) Assignee: Kabushiki Kaisha Toshiba, Minato-ku (JP)

(21) Appl. No.: 14/867,155

(22) Filed: Sep. 28, 2015

(30) Foreign Application Priority Data
Dec. 16, 2014 (JP) 2014-254173

(51) Int. Cl. G06F 17/22; G06T 13/80

(52) U.S. Cl. CPC G06F 17/2247; G06T 13/80; G06T 2213/04

(57) ABSTRACT

According to an embodiment, an information processing device includes a detector and calculator. The detector is configured to detect end time of an animation which is replayed when page information is read by a browser. The page information at least contains markup language information written in a markup language and style information indicating display format of a document object model element included in the markup language information. The calculator is configured to calculate, from specification information in which rate of change of the animation is specified, the style information, and the end time, at least a single replay time which indicates a time at which the animation is replayed up to the rate of change.

### CROSS-REFERENCE TO RELATED APPLICATIONS

This application is based upon and claims the benefit of priority from Japanese Patent Application No. 2014-254173, filed on Dec. 16, 2014; the entire contents of which are incorporated herein by reference.

### FIELD

An embodiment described herein relates generally to an information processing device, an information processing method, and a computer program product.

### BACKGROUND

Typically, a technology is known in which images are analyzed so as to obtain information therefrom. For example, a technology is known in which images taken using a camera, and images of an animation are analyzed so as to detect the areas of moving objects captured in those images. Moreover, a technology is known for finding a plurality of thumbnails (previews), which appropriately expresses the contents of moving images, by analyzing the images.

However, in the conventional technology, since the analysis of images is done by referring to the pixel values of the images, there is a high load attributed to the analysis.

### BRIEF DESCRIPTION OF THE DRAWINGS

FIG. 1 is a diagram illustrating an exemplary hardware configuration of an information processing system according to an embodiment;

FIG. 2 is a diagram illustrating an exemplary functional configuration of an information processing device according to the embodiment;

FIG. 3 is a diagram illustrating a first example of a function transition-time-function according to the embodiment;

FIG. 4 is a diagram illustrating a second example of the function transition-time-function according to the embodiment;

FIG. 5 is a diagram illustrating an exemplary functional configuration of a server device according to the embodiment;

FIG. 6 is a sequence diagram illustrating a method for activating a detector and a calculator according to the embodiment;

FIG. 7 is a sequence diagram illustrating a method for calculating a replay time according to the embodiment; and

FIG. 8 is a flowchart for explaining the method for calculating the replay time according to the embodiment.

### DETAILED DESCRIPTION

According to an embodiment, an information processing device includes a detector and calculator. The detector is configured to detect end time of an animation which is replayed when page information is read by a browser. The page information at least contains markup language information written in a markup language and style information indicating display format of a document object model element included in the markup language information. The calculator is configured to calculate, from specification information in which rate of change of the animation is specified, the style information, and the end time, at least a single replay time which indicates a time at which the animation is replayed up to the rate of change.

An embodiment is described below in detail with reference to the accompanying drawings.

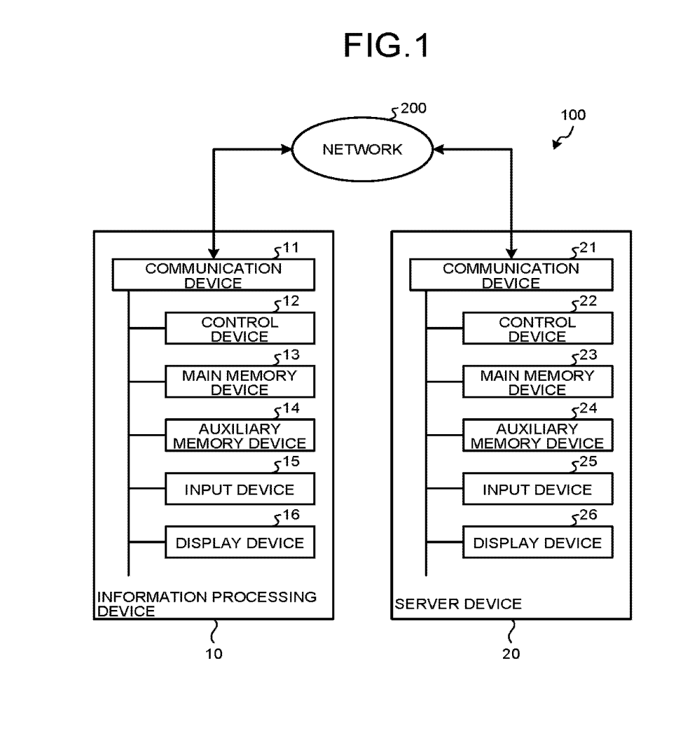

FIG. 1 is a diagram illustrating an exemplary hardware configuration of an information processing system 100 according to the embodiment. The information processing system 100 according to the embodiment includes an information processing device 10 and a server device 20. Herein, the information processing device 10 and the server device 20 are, for example, personal computers, smartphones, or tablet devices. Moreover, the information processing device 10 and the server device 20 are connected via a network 200.

Herein, the network 200 is a wired communication protocol defined by the IEEE802.3 standard, or a wireless communication protocol defined by the IEEE802.11 standard, or a network compatible to some other protocol. Thus, the network 200 is, for example, a communication line such as a local area network (LAN), the Internet, or a dedicated line; or is a communication line configured by combining such communication lines.

The information processing device 10 includes a communication device 11, a control device 12, a main memory device 13, an auxiliary memory device 14, an input device 15, and a display device 16.

The communication device 11 performs communication with other devices such as the server device 20 via the network 200. The control device 12 reads computer programs from the auxiliary memory device 14 into the main memory device 13, and executes them. The control device 12 is, for example, a central processing unit (CPU). The main memory device 13 is a memory such as a read only memory (ROM) or a random access memory (RAM). The auxiliary memory device 14 is used to store data such as computer programs. For example, the auxiliary memory device 14 is a hard disk drive (HDD), a memory card, or an optical drive.

The input device 15 is an interface for enabling operations with respect to the information processing device 10. For example, the input device 15 is a keyboard or a mouse. The display device 16 displays the state of the information processing device 10. For example, the display device 16 is a liquid crystal display. Meanwhile, when the information processing device 10 is a smartphone or a tablet device, the input device 15 and the display device 16 are configured with a touch-sensitive panel.

The server device 20 includes a communication device 21, a control device 22, a main memory device 23, an auxiliary memory device 24, an input device 25, and a display device 26. Herein, the explanation about the communication device 21, the control device 22, the main memory device 23, the auxiliary memory device 24, the input device 25, and the display device 26 is identical to the explanation about the communication device 11, the control device 12, the main memory device 13, the auxiliary memory device 14, the input device 15, and the display device 16, respectively. Hence, the explanation is not repeated.

Given below is the explanation of an exemplary functional configuration of the information processing device 10 according to the embodiment.

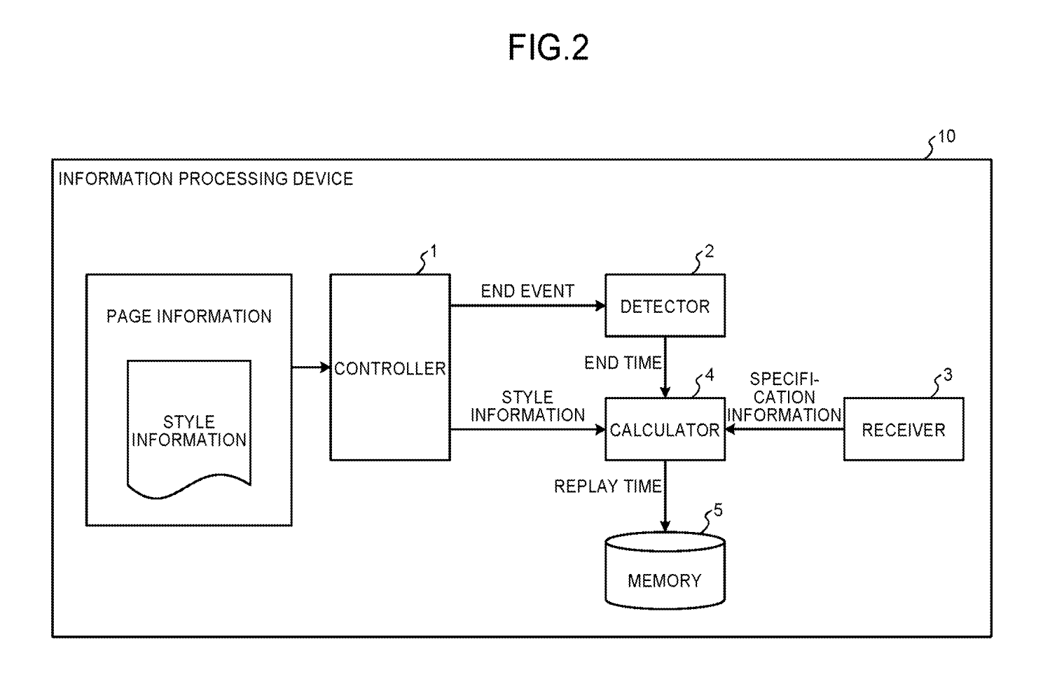

FIG. 2 is a diagram illustrating an exemplary functional configuration of the information processing device 10 according to the embodiment. The information processing device 10 according to the embodiment includes a controller 1, a detector 2, a receiver 3, a calculator 4, and a memory 5. Herein, the memory 5 corresponds to the main memory device 13 and the auxiliary memory device 14.

The controller 1, the detector 2, the receiver 3, and the calculator 4 are implemented in the main memory device 13 when the control device 12 executes a computer program.

Thus, the computer program executed in the information processing device 10 has a module configuration including the functional blocks (the controller 1, the detector 2, the receiver 3, and the calculator 4) illustrated in FIG. 2. The computer program can be written as a browser extension, or may not be included in the browser. In the embodiment, the explanation is given for a case in which the controller 1 represents a browser.

The computer program executed in the information processing device 10 according to the embodiment is recorded as an installable or executable file in a computer-readable memory medium such as a compact disk read only memory (CD-ROM), a memory card, a compact disk readable (CD-R), or a digital versatile disk (DVD); and is provided as a computer program product.

Alternatively, the computer program executed in the information processing device 10 according to the embodiment can be saved as a downloadable file on a computer connected to the network 200 such as the Internet or can be made available for distribution through the network 200 such as the Internet.

Still alternatively, the computer program executed in the information processing device 10 according to the embodiment can be stored in advance in a ROM.

The controller 1 (the browser) issues a request for page information to the server device 20, and receives page information from the server device 20. The following explanation is given about the page information.

The page information contains markup language information written in a markup language; style information; script information; and media resources. The markup information is written using, for example, the hypertext markup language (HTML). The style information indicates the display format of document object model (DOM) elements included in the page information. For example, the style information is written using cascading style sheets (CSS). The script information represents the description for the purpose of dynamically displaying the display information to be displayed by the controller 1 (the browser). Herein, the script information is, for example, JavaScript (registered trademark). The media resources represent, for example, an image file and a video file. When the controller 1 (the browser) reads page information, the display information corresponding to the page information thus read is displayed on the browser.

The controller 1 receives the page information from the server device 20 and deciphers the page information. Herein, deciphering the page information implies parsing the information written using, for example, HTML, CSS, and JavaScript (registered trademark), and configuring a DOM tree. On the basis of the execution result of JavaScript (registered trademark), the controller 1 can sequentially decipher the page information so as to change the configuration of the DOM tree every time deciphering is performed.

Upon completing the deciphering of page information, the controller 1 activates the detector 2 and the calculator 4. Then, the controller 1 receives registration of an event listener from the detector 2 that has been activated. As a result of the registration of an even listener (an event handler) in the controller 1, when the replay of an animation is over, an event is issued from the controller 1 to the detector 2 indicating that the animation replay is over.

The controller 1 replays an animation. When the replay of the animation is over, the controller 1 issues an end event to the detector 2 indicating the end of the animation. The end event represents, for example, “transitioned”. Meanwhile, when a request for style information is received from the calculator 4, the controller 1 inputs the requested style information to the calculator 4.

Upon receiving the end event indicating the end of the animation from the controller 1, the detector 2 notifies the calculator 4 about identification information, such as an ID that enables identification of the animation, and an animation end time indicating the time of receiving the end event.

The receiver 3 receives an operation input indicating specification information in which the rate of change (0% to 100%) of the animation is specified. The method for receiving the specification information can be arbitrary. For example, the receiver 3 receives the operation input, which represents the specification information, from the user via a graphic user interface (GUI) prompt. The specification information can be stored in advance in the ROM of the information processing device 10.

The following explanation is given about the change of rate of the animation. For example, the change of rate of the animation is obtained from a function transition-timing-function of the style information (CSS). The function transition-timing-function is expressed as a straight line or a cubic Bezier curve based on the standard specification of CSS. Herein, the explanation is given about an example of the function transition-timing-function that is expressed as a cubic Bezier curve.

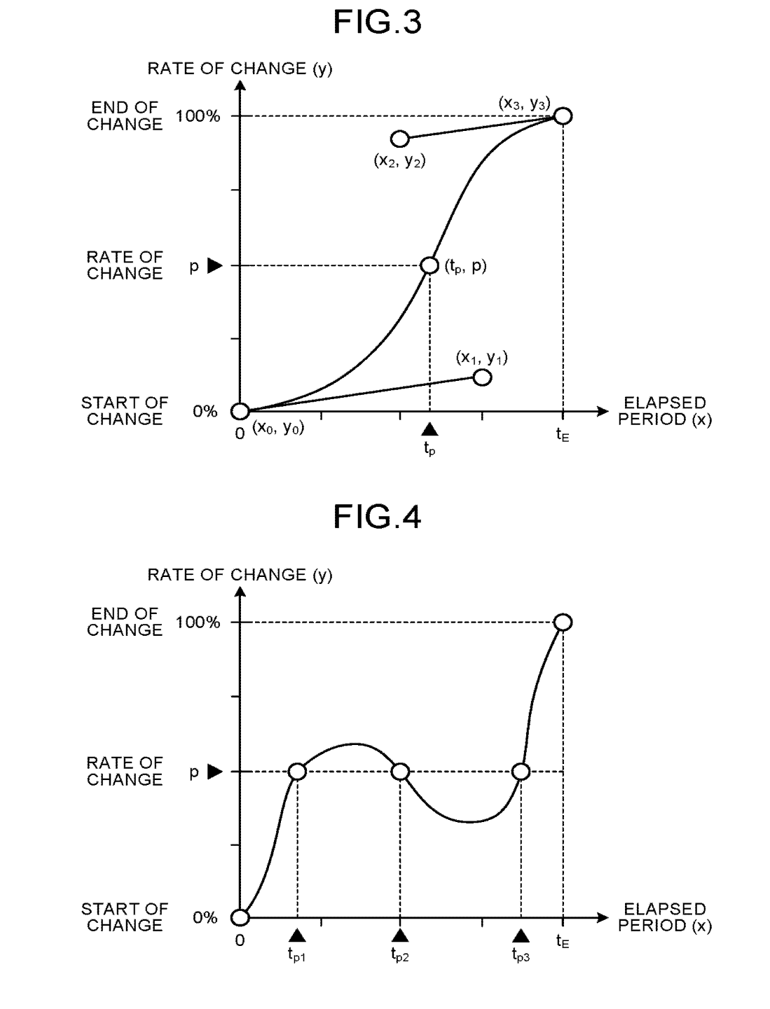

FIG. 3 is a diagram illustrating a first example of the function transition-timing-function. Herein, an elapsed period x represents the period of time elapsed since the start of the animation. Moreover, a rate of change y represents the rate of change in the animation since the start of a change to the end of the change. The target for change is, for example, the transmittance, the color, or the coordinates of the display information that is displayed on the browser. Moreover, (tₚ, p) represents an elapsed period tₚ when the animation reaches a rate of change p. Furthermore, an elapsed period t_{E}(x₃) represents the period of time elapsed when the rate of change of the animation reaches 100% (i.e., when the animation is over).

Moreover, (x₀, y₀), (x₁, y₁), (x₂, y₂), and (x₃, y₃) represent values for determining the cubic Bezier curve. Herein, the cubic Bezier curve is expressed using Equation (1) given below.

x(k)=(1−k)³x₀+3k(1−k)²x₂+3k²(1−k)x₂+k³x₃

y(k)(1−k)³y₀+3k(1−k²y₁+3k²(1−k)y₂+k³y₃ (1)

Furthermore, k represents a parameter that takes a value equal to or greater than zero and equal to or smaller than one. When the style information is CSS, the change due to the cubic Bezier curve is written using, for example, cubic-bezier (x₁, y₁, x₂, y₂), where x₁, Y₁, x₂, and y₂ take arbitrary numerical values.

FIG. 4 is a diagram illustrating a second example of the function transition-timing-function according to the embodiment. In the example illustrated in FIG. 4, there is a plurality of elapsed periods (tₚ₁, tₚ₂, tₚ₃) when the animation reaches the rate of change p. As illustrated in FIG. 4, the elapsed period tₚ corresponding to the time when the animation reaches the rate of change p is not limited to be only one; and there are times when there is a plurality of elapsed periods according to the solutions of Equation (1) of the cubic Bezier curve.

Returning to the explanation with reference to FIG. 2, upon receiving a request for specification information from the calculator 4, the receiver 3 inputs the specification information, in which the rate of change is specified, to the calculator 4.

The calculator 4 receives the animation end time from the detector 2, and then requests the controller 1 for the style information and requests the receiver 3 for the specification information. Then, from the style information indicating the display format of DOM elements included in the page information, the specification information in which the rate of change of the animation is specified, and the animation end time; the calculator 4 calculates at least a single replay time that indicates the time at which the animation is replayed up to the rate of change. The details regarding the method for calculating the replay time are given later with reference to FIG. 8.

Given below is the explanation about an exemplary functional configuration of the server device 20 according to the embodiment.

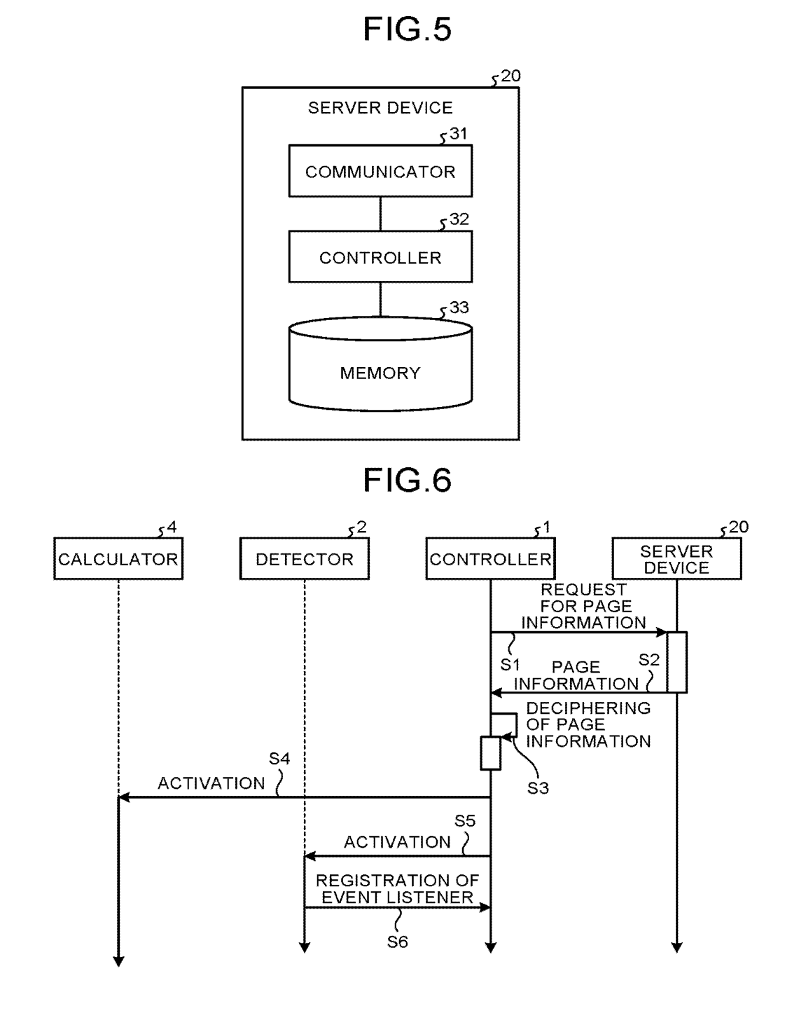

FIG. 5 is a diagram illustrating an exemplary functional configuration of the server device 20 according to the embodiment. The server device 20 according to the embodiment includes a communicator 31, a controller 32, and a memory 33. Herein, the memory 33 corresponds to the main memory device 23 and the auxiliary memory device 24.

The communicator 31 and the controller 32 are implemented in the main memory device 23 when the control device 22 executes a computer program.

Thus, the computer program executed in the server device 20 has a module configuration including the communicator 31 and the controller 32 illustrated in FIG. 5. Moreover, the computer program is written to implement web server functions.

Herein, the computer program executed in the server device 20 according to the embodiment is recorded as an installable or executable file in a computer-readable memory medium such as a CD-ROM, a memory card, a CD-R, or a DVD; and is provided as a computer program product.

Alternatively, the computer program executed in the server device 20 according to the embodiment can be saved as a downloadable file on a computer connected to the network 200 such as the Internet or can be made available for distribution through the network 200 such as the Internet.

Still alternatively, the computer program executed in the server device 20 according to the embodiment can be stored in advance in a ROM.

The communicator 31 receives a request for page information from the information processing device 10, and inputs the request for page information to the controller 32.

Upon receiving the request for page information from the communicator 31, the controller 32 obtains the requested page information from the memory 33 and sends the page information to the information processing device 10 via the communicator 31.

Given below is the explanation of an information processing method according to the embodiment.

FIG. 6 is a sequence diagram illustrating a method for activating the detector 2 and the calculator 4. Firstly, the controller 1 (the browser) sends a request for page information to the server device 20 (Step S1). In response, the server device 20 sends the requested page information to the controller 1 (Step S2). Then, the controller 1 deciphers the page information (Step S3). Subsequently, the controller 1 activates the calculator 4 (Step S4). Then, the controller 1 activates the detector 2 (Step S5). Subsequently, the detector 2 registers an event listener in the controller 1 (Step S6).

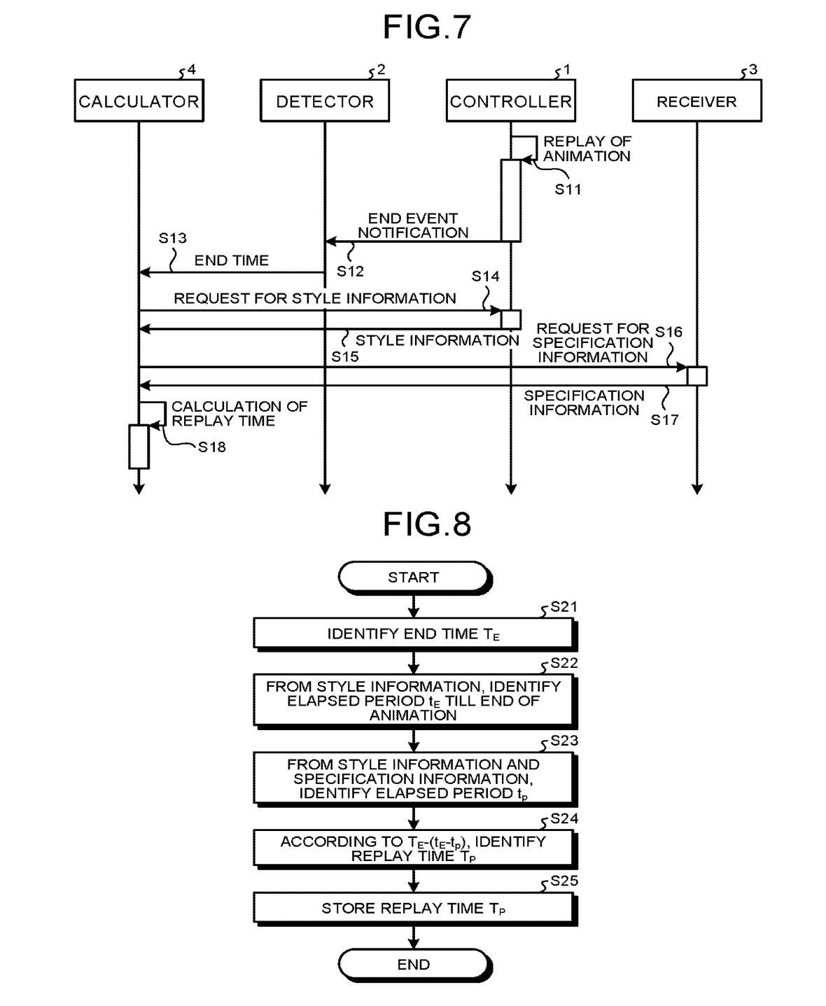

FIG. 7 is a sequence diagram illustrating a method for calculating the replay time according to the embodiment. Firstly, the controller 1 replays the animation (Step S11). More particularly, the controller 1 deciphers the page information and configures a DOM tree. Then, according to the description in the style information (CSS) and the script information (JavaScript (registered trademark)), the controller 1 sequentially changes the appearance of the DOM elements constituting the DOM tree, and starts the animation.

For example, with respect to an arbitrary DOM element, when “transition: left 3 s cubic-bezier (x₁, y₁, x₂, y₂) 1 s;” is given as the description based on the standard specification of CSS, the x-coordinate of the concerned DOM element is changed over a period of three seconds after a delay of one second at the pace according to the cubic Bezier curve cubic-bezier (x₁, y₁, x₂, y₂).

The origin for starting the animation represents the point of time at which the style information is applied to the display information that is displayed by the controller 1 (the browser). The origin implies the point of time at which deciphering of the page information is completed, or implies the time when there is a change in the style information applied due to changes in the classes of the DOM elements, or implies the time when the style information of the DOM elements is directly specified as a result of executing JavaScript (registered trademark).

When replay of the animation is over, the controller 1 issues an end event to the detector 2 indicating the end of the animation (Step S12). Then, the time of receiving the end event from the controller 1 is notified as the animation end time to the calculator 4 (Step S13). Subsequently, the calculator 4 requests the controller 1 for style information (Step S14). Then, the controller 1 inputs the requested style information to the calculator 4 (Step S15). Subsequently, the calculator 4 requests the receiver for specification information (Step S16). Then, the receiver 3 inputs the requested specification information to the calculator 4 (Step S17).

Subsequently, from the style information indicating the display format of the DOM elements included in the page information, the specification information in which the rate of change of the animation is specified, and the animation end time; the calculator 4 calculates at least a single replay time that indicates the time at which the animation is replayed up to the rate of change (Step S18).

Given below is the detailed explanation of the method implemented at Step S18 for calculating the replay time.

FIG. 8 is a flowchart for explaining the method for calculating the replay time according to the embodiment. Firstly, the calculator 4 identifies an end time T_{E} from the notification received from the detector 2 at Step S13 (Step S21).

Then, from the style information received from the controller 1 at Step S15, the calculator 4 identifies an elapsed period t_{E} till the end of the animation (see FIG. 3) (Step S22). More particularly, the calculator 4 parses the description of the style information (CSS), identifies the style information to be applied to the DOM elements, and obtains the function transition-timing-function (see FIG. 3) included in the identified style information. Moreover, for example, according to types, IDs, and classes of the DOM elements, the calculator 4 identifies the style information to be applied to the DOM elements.

Meanwhile, at Step S15 described above, the calculator 4 can inquire the controller 1 (the browser) not only about the style information (CSS) but also about the style that is actually applied to the DOM elements (i.e., about what is called the computed style), and can obtain the function transition-timing-function from the computed style.

Meanwhile, the time of obtaining the function transition-timing-function can be arbitrary. For example, the calculator 4 can obtain the function transition-timing-function in advance and store it, and can refer to it at the time of calculating the replay time.

Subsequently, the calculator 4 identifies the elapsed period t_{P} (see FIG. 3) from the style information and the specification information (Step S23).

Then, according to T_{E}−(t_{E}−t_{P}), the calculator 4 identifies a replay time Tₚ at which the animation is replayed up to the rate of change specified in the specification information (Step S24). Moreover, when a plurality of replay times Tₚ can be identified as illustrated in FIG. 4, the calculator 4 identifies all replay times Tₚ₁, Tₚ₂, and Tₚ₃ from elapsed periods tₚ₁, tₚ₂, and tₚ₃, respectively, according to T_{E}−(t_{E}−tₚ₁), T_{E}−(t_{E}−tₚ₂), and T_{E}−(t_{E}−tₚ₃), respectively.

Then, the calculator 4 stores the replay time Tₚ in the memory 5 (Step S25). Meanwhile, the calculator 4 can send the replay time Tₚ to another program running in the information processing device 10 by means of inter-process communication, or can send the replay time Tₚ to another device connected to the network 200 by the WebSocket protocol.

As described above, in the information processing device 10 according to the embodiment, the detector 2 detects the end time of the animation that is replayed when the controller 1 (the browser) reads page information which at least contains the markup language information written in a markup language and the style information indicating the display format of the DOM elements included in the markup language information. Then, from the style information indicating the display format of the DOM elements included in the page information, the specification information in which the rate of change of the animation is specified, and the animation end time; the calculator 4 calculates at least a single replay time that indicates the time at which the animation is replayed up to the rate of change. With that, in the information processing device 10 according to the embodiment, without having to perform image analysis in which the pixel values of display information are referred to, it becomes possible to obtain the replay time indicating the time at which the animation is replayed up to an arbitrary rate of change. That is, in the information processing device 10 according to the embodiment, the replay time, which indicates the time at which the animation is replayed up to an arbitrary rate of change, can be obtained while holding down the processing load at a lower level.

The replay time calculated by the calculator 4 according to the embodiment can be used in creating a plurality of thumbnails (previews) that expresses the contents of the animation in an appropriate manner.

Meanwhile, instead of implementing some or all of the functional blocks illustrated in FIG. 2 (i.e., the controller 1, the detector 2, the receiver 3, and the calculator 4) using software, some or all of the functional blocks can be implemented using hardware such as an integrated circuit (IC).

Moreover, instead of storing the page information in the memory 33 of the server device 20, the page information can be stored in the memory 5 of the information processing device 10.

Furthermore, the specification information can alternatively be identified by the calculator 4 by making the calculator 4 read a setting file in which the specification information is stored or by writing variables indicating the specification information in the computer program that implements the calculator 4.

Meanwhile, the information obtained from the style information (CSS) can be “animation” instead of “transition”. Herein, in “animation”, the movement of DOM elements is defined as what is called a key frame. In the case of “animation”, the rate of change is expressed by, for example, connecting a plurality of cubic Bezier curves illustrated in FIGS. 3 and 4. However, the calculation of the replay time is identical to that in the case of “transition”. That is, the replay time can be calculated from the cubic Bezier curve corresponding to each frame.

While a certain embodiment has been described, the embodiment has been presented by way of example only, and is not intended to limit the scope of the inventions. Indeed, the novel embodiment described herein may be embodied in a variety of other forms; furthermore, various omissions, substitutions and changes in the form of the embodiment described herein may be made without departing from the spirit of the inventions. The accompanying claims and their equivalents are intended to cover such forms or modifications as would fall within the scope and spirit of the inventions.

What is claimed is:

1. An information processing device comprising:
a detector configured to detect end time of an animation which is replayed when page information is read by a browser, the page information at least containing markup language information written in a markup language and style information indicating display format of a document object model element included in the markup language information; and
a calculator configured to calculate, from specification information in which rate of change of the animation is specified, the style information, and the end time, at least a single replay time which indicates a time at which the animation is replayed up to the rate of change.

2. The device according to claim 1, wherein the calculator
calculates, from the style information and the specification information, difference between an elapsed period from start up to end of the animation and an elapsed period when the animation is replayed from start up to the rate of change, and
calculates the replay time from the difference and the end time.

3. The device according to claim 1, wherein the rate of change is 0% and the replay time is start time of the animation.

4. The device according to claim 1, wherein the style information represents cascading style sheets (CSS).

5. The device according to claim 1, wherein the style information represents the style information that is already calculated and that is stored by the browser.

6. An information processing method comprising:
detecting end time of an animation which is replayed when page information is read by a browser, the page information at least containing markup language information written in a markup language and style information indicating display format of a document object model element included in the markup language information; and
calculating, from specification information in which rate of change of the animation is specified, the style information, and the end time, at least a single replay time which indicates a time at which the animation is replayed up to the rate of change.

7. A computer program product comprising a computer readable medium including programmed instructions, wherein the programmed instructions, when executed by a computer, cause the computer to function as:
a detector configured to detect end time of an animation which is replayed when page information is read by a browser, the page information at least containing markup language information written in a markup language and style information indicating display format of a document object model element included in the markup language information; and
a calculator configured to calculate, from specification information in which rate of change of the animation is specified, the style information, and the end time, at least a single replay time which indicates a time at which the animation is replayed up to the rate of change.
